(19) United States
(12) Patent Application Publication
(10) Pub. No.: US 2009/0190025 A1
(43) Pub. Date: Jul. 30, 2009

(54) Image-capturing module and manufacturing method thereof

(75) Inventor: Hsin-Chieh Lu, Kaohsiung (TW)

Correspondence Address: BACON & THOMAS, PLLC, 625 SLATERS LANE, FOURTH FLOOR, ALEXANDRIA, VA, 22314-1176, US

(73) Assignee: Advanced Semiconductor Engineering, Inc., Kaohsiung (TW)

(21) Appl. No.: 12/320,084

(22) Filed: Jan. 16, 2009

(30) Foreign Application Priority Data
Jan. 24, 2008 (TW) 97102716

(51) Int. Cl. H04N 5/225; G02B 7/02; B23P 19/00

(52) U.S. Cl. 348/374; 359/819; 29/739; 348/E05.024

(57) ABSTRACT

An image-capturing module and a manufacturing method thereof are provided. The image-capturing module includes a circuit board, an electric element, a lens set and a carrier. The circuit board has at least a locking hole. The electric element is disposed on the circuit board. The carrier is disposed on the circuit board for carrying the lens set. The carrier has at least a hook locking at the locking hole of the circuit board.

This application claims the benefit of Taiwan application Serial No. 97102716, filed Jan. 24, 2008, the subject matter of which is incorporated herein by reference.

### BACKGROUND OF THE INVENTION

1. Field of the Invention

The invention relates in general to an image-capturing module and a manufacturing method thereof, and more particularly to an image-capturing module with a carrier for carrying a lens set and a manufacturing method thereof.

2. Description of the Related Art

As the trend is toward more compact electronic products, the development of all kinds of image-capturing modules is continuously toward miniaturization. The image-capturing module mainly includes a circuit board, an electric element and a lens set. The electric element is disposed on the circuit board. The lens set is disposed on the electric element. After passing through the lens set, light is focused at the electric element, for acquiring image information.

Generally speaking, optic devices have high requirement on accuracy. During the assembling process of the image-capturing module, a series of optical tests are conducted for ensuring that the assembled image-capturing module functions normally.

During the optical tests, no components are allowed to move. The movement of the components affects not only the test results but also the yield rate of the final products. Therefore, before the optical tests are conducted, an adhesive is used for connecting the components for maintaining the stability of each component.

However, a few adhered image-capturing modules are defective. Because some components are adhered, these components cannot be re-worked, which results in waste of material and lower yield rate.

Therefore, it is very important to provide an image-capturing module and a manufacturing method thereof to lower the manufacturing cost and increase the product yield rate.

### SUMMARY OF THE INVENTION

The invention is directed to an image-capturing module and a manufacturing method thereof. A hook of a carrier cooperates with a locking hole of a circuit board to lower the manufacturing cost and increase the product yield rate.

According to the present invention, an image-capturing module is provided. The image-capturing module includes a circuit board, an electric element, a lens set and a carrier. The circuit board has at least a locking hole. The electric element is disposed on the circuit board. The carrier is disposed on the circuit board for carrying the lens set. The carrier has at least a hook locking at the locking hole of the circuit board.

According to the present invention, a manufacturing method of an image-capturing module including following steps is provided. First, a circuit board is provided. The circuit board has at least a locking hole. Next, an electric element is disposed on the circuit board. Then, a lens set and a carrier are disposed on the circuit board. The carrier carries the lens set and has at least a hook. The hook of the carrier locks at the locking hole. After, the electric element and the lens set are tested.

The invention will become apparent from the following detailed description of the preferred but non-limiting embodiments. The following description is made with reference to the accompanying drawings.

### BRIEF DESCRIPTION OF THE DRAWINGS

FIG. 1 is a flow chart of a manufacturing method of an image-capturing module according to a preferred embodiment of the present invention;

FIGS. 2A˜2F illustrate steps in FIG. 1;

FIGS. 3A˜3F illustrate FIGS. 2A˜2F from another viewing angle;

FIG. 4 illustrates the lens set, the carrier and the circuit board in FIG. 3C viewed from the y-z plane; and

FIG. 5 is another view of the lens set, the carrier and the circuit board viewed from the y-z plane.

### DETAILED DESCRIPTION OF THE INVENTION

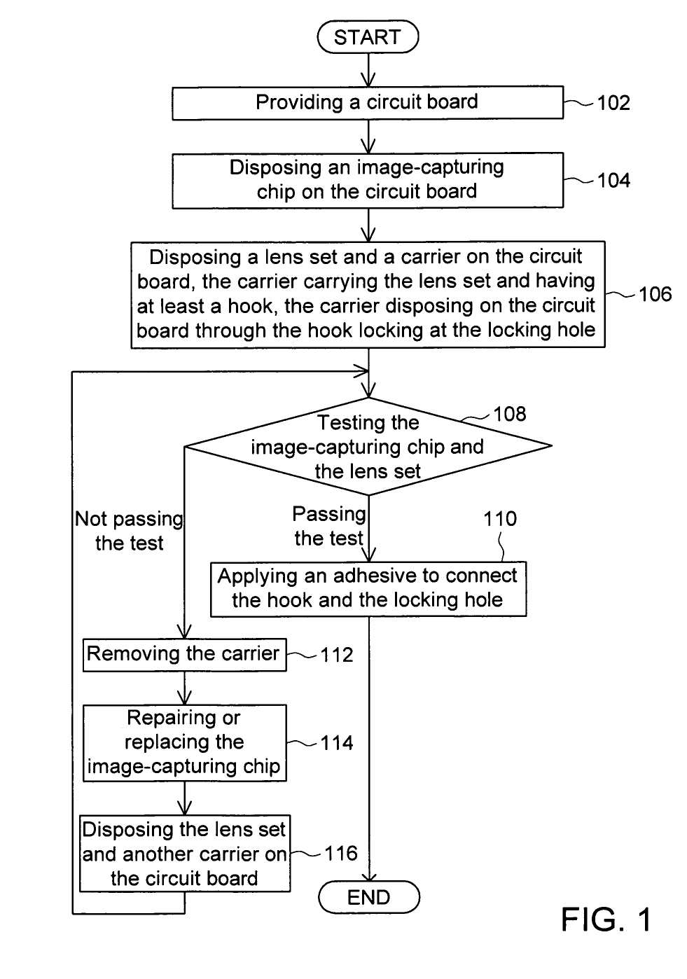

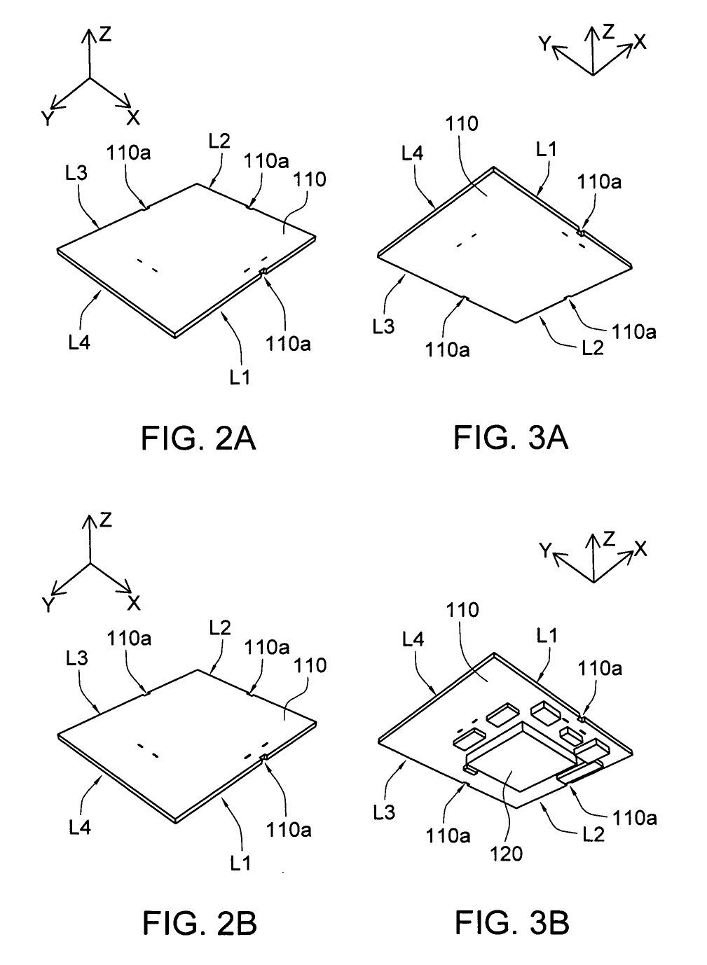

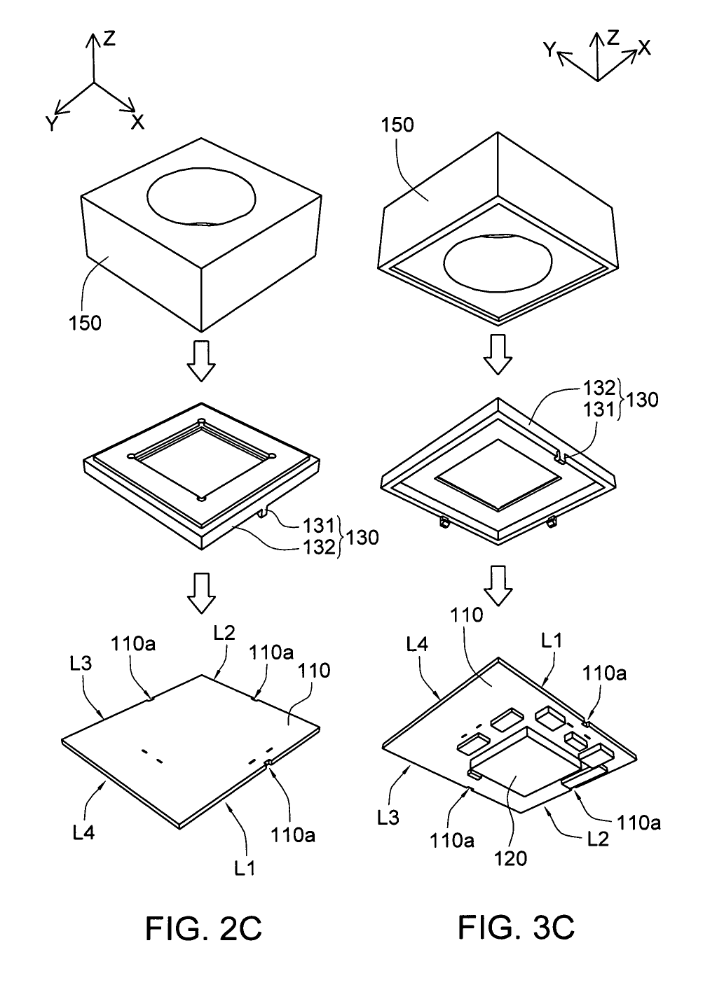

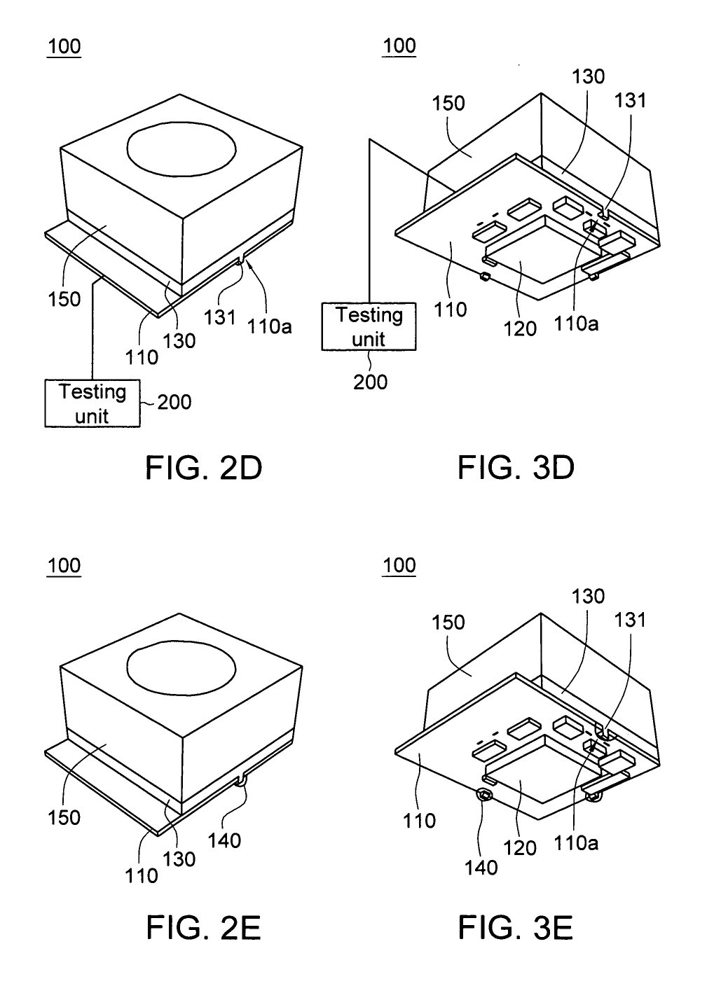

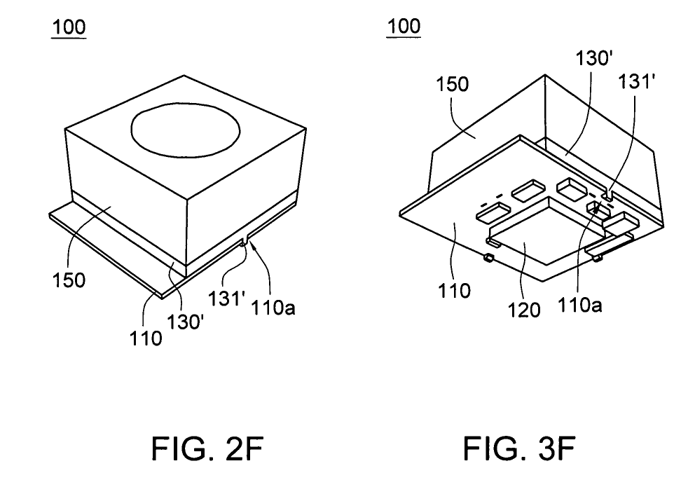

Please refer to FIG. 1, FIGS. 2A˜2F and FIGS. 3A˜3F at the same time. FIG. 1 is a flow chart of a manufacturing method of an image-capturing module 100 according to a preferred embodiment of the present invention. FIGS. 2A˜2F illustrate steps in FIG. 1. FIGS. 3A˜3F illustrate FIGS. 2A˜2F from another viewing angle. First, please referring FIG. 2A and FIG. 3A, a circuit board 110 is provided in a step 102. The circuit board 110 is for example one of the circuit boards in a combined circuit board (not shown in drawings). Several image-capturing modules 100 (shown in FIG. 2F) are preferably manufactured directly on a combined circuit board. After the manufacture of the image-capturing modules 100 is accomplished, the combined circuit board is cut to form several image-capturing modules 100.

The circuit board 110 has at least a locking hole 110a. The number and location of the locking holes 110a are decided according to the circuit design of the circuit board 110 or the required structure strength. As shown in FIG. 2A and FIG. 3A, the circuit board 110 of the present embodiment is a rectangular structure and has four sides L1, L2, L3 and L4. The side L4 is for disposing several long strips of conductive pads (also called gold fingers). Therefore, the side L4 is not suitable for forming the locking hole 110a. In the present embodiment, the circuit board 110 has three locking holes 110a formed on three sides L1, L2 and L3 of the circuit board 110 as an example. The three locking holes 110a are concavities on the three sides L1, L2 and L3.

Next, please referring to FIG. 2B and FIG. 3B, an electric element 120 is disposed on the circuit board 110 in a step 104. The electric element 120 is for example a chip or a passive device. The electric element 120 can be disposed on the front side, the back side or both sides of the circuit board 110. In the present embodiment, the electric element 120 is an image-capturing chip, such as a complementary metal-oxide-semiconductor (CMOS) or a charge-coupled device (CCD). All kinds of electric elements 120 can be applied to the image-capturing module 100 (shown in FIG. 2F) of the present embodiment.

Then, please referring to FIG. 2C and FIG. 3C, a lens set 150 and a carrier 130 are disposed on the circuit board 110 in a step 106. The carrier 130 carries the lens set 150. The lens set 150 preferably includes a single lens, several lenses or several lens assemblies. In the lens set 150 requiring higher accuracy, preferably the lens set 150 further includes an actuator, for driving the lens to move relatively to the electric element 120.

The carrier 130 includes a carrier main body 132 and at least a hook 131. Each hook 131 of the carrier 130 locks at one of the locking hole 110a. In other words, the carrier 130 and the circuit board 110 are connected only through the hooks 131 but not through an adhesion. The number and location of the hooks 131 are decided according to the circuit design of the circuit board 110 and the required structure strength. Take the circuit board 110 in FIG. 2A for example. The circuit board 110 has three locking holes 110a formed on three sides L1, L2 and L3, and the three locking holes 110a are concavities on the sides L1, L2 and L3. Accordingly, the carrier 130 has three hooks 131 whose locations are corresponding to those of the three locking holes 110a.

In this step, the hooks 131 of the carrier 130 cooperate with the locking holes 110a of the circuit board 110. Therefore, no adhesive is needed (in this step, no adhesive is used and therefore not shown in the drawing) to achieve the requirement of accurate alignment. Furthermore, the assembling workers or the automatic machine only needs to lock the hooks 131 at the locking holes 110a to dispose the carrier 130 on the circuit board 110. Therefore, the assembling step is very convenient.

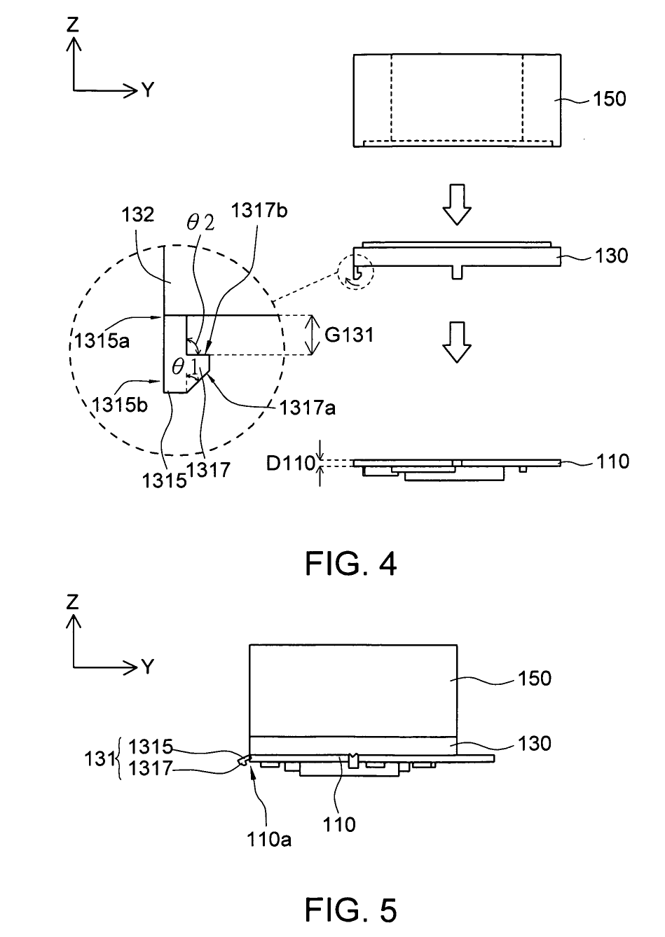

FIG. 4 illustrates the lens set 150, the carrier 130 and the circuit board 110 in FIG. 3C viewed from the y-z plane. Please referring to FIG. 4, more particularly, each hook 131 includes a pin 1315 and a protruding part 1317. The pin 1315 has a front end 1315a and a back end 1315b. The front end 1315a of the pin 1315 is coupled with the carrier main body 132. The protruding part 1317 is disposed on the back end 1315b of the pin 1315.

The protruding part 1317 protrudes toward the center of the carrier main body 132. Therefore, when the hook 131 enters the locking hole 110a (shown in FIG. 2C), the protruding part 1317 is within the range of the circuit board 110. Accordingly, the protruding part 1317 and the carrier main body 132 clamp two side surfaces of the circuit board 110, so that the circuit board 110 does not depart from the carrier 130.

Moreover, a distance G131 between the protruding part 1317 and the carrier main body 132 is slightly greater than the thickness D110 of the circuit board 110. As a result, when the hook 131 enters the locking hole 110a, the protruding part 1317 and the carrier main body 132 contact the two side surfaces of the circuit board 110. Therefore, after the carrier 130 is disposed on the circuit board 110, the carrier 130 does not sway on the circuit board 110.

Besides, in order to enable the hook 131 (please referring to FIG. 3C) to enter the locking hole 110a smoothly, at least part of the cross-section of the protruding part 1317 gradually decreases along the direction from the front end 1315a towards the back end 1315b (that is, −z direction). As a result, the sharp back end 1315b of the protruding part 1317 with smaller cross-section is able to enter the locking hole 110a.

As to the shape of the protruding part 1317, the protruding part 1317 has a first surface 1317a and a second surface 1317b. The first surface 1317a is adjacent to the back end 1315b of the pin 1315. The second surface 1317b is adjacent to the front end 1315a of the pin 1315. The angle between the first surface 1317a and the extending direction (the −z direction) of the pin 1315 is substantially an acute angle θ1. The design of the acute angle θ1 guides the hook 131 to slide into the locking hole 110a. Therefore, when the hook 131 enters the locking hole 110a, there is no need to apply too much force to push the hook 131 into the locking hole 110a.

Moreover, the angle between the second surface 1317b and the extending direction (−z direction) of the pin 1315 is substantially a right angle θ2. When the hook 131 enters the locking hole 110a, the second surface 1317b of the protruding part 1317 contacts a side surface of the circuit board 110. As a result, through the design of the right angle θ2, the second surface 1317b of each protruding part 1317 locks at the circuit board 110 stably and flatly without swaying. Further, because the angel between the second surface 1317b and the extending direction (−z direction) of the pin 1315 is substantially a right angle θ2, the protruding part 1317 does not depart from the locking hole 110a easily.

After, please referring to FIG. 2D and FIG. 3D, a testing unit 200 tests the electric element 120 and the lens set 150 at a step 108. Generally speaking, the image-capturing module 100 has high requirement on assembling accuracy. After the electric element 120 and the lens set 150 are assembled, a series of optical tests are conducted, such as electrical connection test of the electric element 120, focus alignment test, color shift test, etc.

However, during the tests, the carrier 130 and the lens set 150 need to have certain stability to perform tests. Through the cooperation of the hook 131 of the carrier 130 and the locking hole 110a of the circuit board 110, the carrier 130 is aligned accurately on the circuit board 110 and stably locks at the circuit board 110. Therefore, during the tests, the stability of the assembled carrier 130, the lens set 150 and the circuit board 110 meets the requirement of the tests.

In the step 108, when the electric element 120 and the lens set 150 pass the test, the method goes to a step 110. When the electric element 120 and the lens set 150 do not pass the test, the method goes to steps 112, 114 and 116. The two cases are illustrated as followed.

First, the step 110 is described. In the step 108, when the electric element 120 and the lens set 150 pass the test, the method goes to the step 110. Please refer to FIGS. 2E and 3E. In the step 110, when the electric element 120 and the lens set 150 pass the test, an adhesive 140 is applied to connect the hook 131 and the locking hole 110a. After the adhering step, the manufacture of the image-capturing module 100 is accomplished. The adhesive 140 is for example a UV-curing adhesive or a thermosetting adhesive. The adhesive 140 of the present embodiment is a thermosetting adhesive as an example, and the adhesive 140 is cured through heat.

The hook 131 is adhered to the locking hole 110a through the adhesive 140 after the electric element 120 and the lens set 150 pass the test. Therefore, the adhered image-capturing module 100 is qualified and needs no remanufacture.

Next, the steps 112,114 and 116 are described. In the step 108, when the electric element 120 and the lens set 150 do not pass the test, the method goes to the steps 112,114 and 116. Please refer to FIGS. 2D and 3D. In the step 112, when the electric element 120 and the lens set 150 do not pass the test, the carrier 130 is removed. In this step, the carrier 130 is removed by breaking the hook 131. Please refer to FIG. 5, which is another view of the lens set 150, the carrier 130 and the circuit board 110 viewed from the y-z plane. The locking holes 110a of the circuit board 110 are concavities formed on the sides L1, L2 and L3 (please referring to FIG. 3C). Therefore, the repair worker or the automatic machine only needs to fold the hook 131 outwards to break the pin 1315 of the hook 131. As a result, the carrier 130 is removed smoothly and successfully. The carrier 130 does not cost much, but the circuit board 110 and the electric element 120 are expensive. Accordingly, when the carrier 130 is removed through this method, only inexpensive carrier 130 is damaged, and the expensive circuit board 110 and electric element 120 are not damaged. The manufacturing cost is saved greatly.

Thereon, in the step 114, the electric element 120 is repaired or replaced. After the carrier 130 is removed, the electric element 120 can be repaired or replaced. When the precision of the conductive leads or conductive bumps of the electric element 120 is higher, it is difficult to repair the electric element directly on the circuit board 110. It is preferable to directly replace the original electric element with another good electric element 120. The removed electric element 120 is then repaired through chip test, chip maintenance or conductive bump reforming.

Please refer to FIG. 2F and FIG. 3F. Subsequently, the lens set 150 and another carrier 130′ are disposed on the circuit board 110 in the step 116. The lens set 150 can be the original one or another lens set (in the present embodiment, the original lens set 150 is used as an example, so another lens set is not shown in the drawings). The another carrier 130′ also includes at least a hook 131′. The number and location of the hooks 131′ are preferably decided according to the circuit design of the circuit board 110 or the required structure strength. Take the circuit board 110 in FIG. 2A for example. The carrier 130′ includes three hooks 131′ whose locations are corresponding to those of the three locking holes 110a. The carrier 130′ is disposed on the circuit board 110 through the hooks 131′ locking at the locking holes 110a.

After the maintenance and repair steps in the steps 112, 114 and 116, the method goes back to the step 108. A test is then conducted for ensuring the quality of the electric element 120 and the lens set 150.

In the image-capturing module and the manufacturing method thereof revealed in the above embodiment of the present invention, the hook of the carrier cooperates with the locking hole of the circuit board. As a result, the image-capturing module has many advantages. Only some of the advantages are illustrated as followed.

First, in the step of disposing the carrier on the circuit board, the hook of the carrier cooperates with the locking hole of the circuit board. There is no need to use adhesive to meet the requirement of accurate alignment before the test.

Second, in the step of disposing the carrier on the circuit board, no adhesive is used, which further avoid the problem that the carrier is uneven caused by the adhesive.

Third, in the step of disposing the carrier on the circuit board, the assembling worker only needs to push the hook into the locking hole to finish the step. Therefore, the assembling step is very convenient.

Fourth, all the protruding parts protrude toward the center of the carrier main body. When the hook enters the locking hole, the protruding part is within the range of the circuit board. Accordingly, the protruding part and the carrier main body clamp the two side surfaces of the circuit board, so that the circuit board does not depart from the carrier.

Fifth, the distance between the protruding part and the carrier main body is slightly greater than the thickness of the circuit board. As a result, when the hook enters the locking hole, the protruding part and the carrier main body contacts the two side surfaces tightly. Therefore, after the carrier is disposed on the circuit board, the carrier does not sway on the circuit board.

Sixth, the cross-section of the protruding part gradually decreases along a direction from the front end toward the back end. The angle between the first surface and the extending direction of the pin is substantially an acute angle. Through the design of the cross-section and the acute angle, after the hook enters the locking hole, there is no need to apply too much force to push the hook into the locking hole.

Seventh, the angle between the second surface and the extending direction of the pin is substantially a right angle. When the hook enters the locking hole, the second surface of the protruding part contacts one side surface of the circuit board. As a result, through the design of the right angle, the second surface of each protruding part contacts the surface of the circuit board, so that each hook locks at the circuit board stably without swaying.

Eighth, because the angle between the second surface and the extending direction of the pin is substantially a right angle, the protruding part does not depart from the locking hole easily.

Ninth, the hook is adhered to the locking hole by the adhesive after the electric element and the lens set pass the test. Therefore, the adhered image-capturing module is good and needs no remanufacture.

Tenth, through the above manufacturing method, when the electric element or the lens set is defective, the carrier is removed to perform maintenance. There is no need to discard the defective item directly.

Eleventh, through the above method, when the carrier is removed, only the inexpensive carrier is damage. The expensive circuit board and electric element are not damaged. Therefore, the manufacturing cost is saved greatly.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image-capturing module, comprising:
a circuit board, having at least a locking hole;
an electric element, disposed on the circuit board;
a lens set; and
a carrier, disposed on the circuit board for carrying the lens set, the carrier comprising at least a hook locking at the locking hole of the circuit board.

2. The module according to claim 1 further comprising:
an adhesive encapsulating the hook and the locking hole for connecting the hook and the locking hole.

3. The module according to claim 1, wherein the locking hole is a concavity on a side of the circuit board.

4. The module according to claim 1, wherein the hook comprises:
a pin having a front end and a back end, the front end of the pin coupled with a carrier main body of the carrier; and
a protruding part disposed at the back end of the pin.

5. The module according to claim 4, wherein at least part of the cross-section of the protruding part decreases gradually along a direction from the front end toward the back end.

6. The module according to claim 4, wherein the protruding part has a first surface and a second surface, the first surface is adjacent to the back end of the pin, the second surface is adjacent to the front end of the pin, the angle between the first surface and an extending direction of the pin is substantially an acute angle, and the angle between the second surface and the extending direction of the pin is substantially a right angle.

7. The module according to claim 4, wherein a distance between the protruding part and the carrier main body is slightly greater than the thickness of the circuit board.

8. The module according to claim 4, wherein the protruding part protrudes toward the center of the carrier main body.

9. The module according to claim 1, wherein the circuit board has two locking holes formed on two opposite sides of the circuit board, and the carrier comprises two hooks corresponding to the locking holes.

10. The module according to claim 1, wherein the circuit board has three locking holes formed on three sides of the circuit board, and the carrier comprises three hooks corresponding to the locking holes.

11. A manufacturing method of an image-capturing module, the method comprising:
providing a circuit board having at least a locking hole;
disposing an electric element on the circuit board;
disposing a lens set and a carrier on the circuit board, the carrier carrying the lens set and comprising at least a hook, the hook of the carrier locking at the locking hole; and
testing the electric element and the lens set.

12. The method according to claim 11 further comprising:
applying an adhesive for connecting the hook and the locking hole.

13. The method according to claim 12, wherein the step of applying the adhesive for connecting the hook and the locking hole further comprises:
curing the adhesive through heat.

14. The method according to claim 11 further comprising:
removing the carrier;
repairing or replacing the electric element; and
disposing the lens set and another carrier on the circuit board, the another carrier comprising at least another hook, the another carrier disposed on the circuit board through the another hook of the another carrier locking at the locking hole.

15. The method according to claim 14, wherein in the step of removing the carrier, the carrier is removed by breaking the hook.

16. The method according to claim 11, wherein in the step of providing the circuit board, the locking hole is a concavity on a side of the circuit board.

17. The method according to claim 11, wherein the step of providing the circuit board, the step of disposing the electric element on the circuit board, the step of disposing the lens set and the carrier on the circuit board and the step of testing the electric element and the lens set are performed orderly.
